(19) United States
(12) Patent Application Publication
(10) Pub. No.: US 2020/0023528 A1
(43) Pub. Date: Jan. 23, 2020

(54) UTILITY KNIFE

(71) Applicant: MARTOR KG, Solingen (DE)

(72) Inventors: Martin ROHRBACH, Goegginen-Horn (DE); Kerry HENN, Solingen (DE)

(21) Appl. No.: 16/374,552

(22) Filed: Apr. 3, 2019

(30) Foreign Application Priority Data
Jul. 17, 2018 (DE) 102018117203.6

(51) Int. Cl. B26B 5/00

(52) U.S. Cl. CPC B26B 5/003

(57) ABSTRACT

The invention relates to a utility knife comprising a first part (11) and comprising a second part (12) that is mounted so as to be movable relative to the first part (11), and comprising a blade assembly having a blade (16), and comprising an actuator having at least two links (17, 18) that hingedly interconnect the blade assembly and the first part (11) such that a mechanical linkage is formed that is movable by relative movement between the first part (11) and the second part (12), between at least one rear end position and at least one front end position, wherein the second part (12) is indirectly or directly movably connected to one of the links (18) or to the blade assembly in order to move the mechanical linkage.

The invention relates to a utility knife.

A utility knife of this kind is known from U.S. Pat. No. 9,370,869. This utility knife comprises a blade support holding a blade and mounted on a housing by two links such that the blade support is movable between a safety position in which the blade is recessed in the housing and a cutting position in which the blade projects with respect to the housing. The housing, the link and the blade support form a four-bar linkage. The links are arranged so as to be mutually parallel as a result of which the utility knife forms a parallelogram four-bar linkage.

The object of the invention was that of providing a utility knife that has advantageous properties with respect to the course of movement of the blade support.

The object was achieved by a utility knife having the features of claim 1.

The utility knife comprises a first part and a second part that is mounted so as to be able to perform a relative movement with respect to the first part. By relative movement between the first part and the second part, the blade assembly can be moved for example between the rear end position and the front end position. Alternatively, owing to the relative movement of the first part with respect to the second part, the blade assembly can be moved between the rear end position and a position between the rear end position and the front end position.

The utility knife further comprises a blade assembly. The blade assembly comprises for example a blade support and a blade that is held on the blade support. Alternatively, the blade assembly may also merely comprise a blade.

Furthermore, the utility knife comprises an actuator. The blade can be moved between at least one rear end position and at least one front end position using the actuator. The rear end position is for example a safety position, and the front end position is for example a cutting position or for example a blade replacement position. In the safety position, the blade is received in a housing such that the user cannot injure themselves. In the cutting position, the blade projects from the housing such that it is possible to perform a cutting process.

The actuator comprises at least one first link and one second link, wherein each link together with the blade assembly and with the first part or with the second part forms a pivot such that a mechanical linkage is formed. The blade is for example directly or indirectly connected to the links. For example, the blade is firmly held in a blade holder. The links in each case form a pivot, for example together with the blade holder. According to an alternative, each link forms a pivot directly together with the blade.

The blade assembly and the link are guided for example only by the pivots. According to an alternative, the blade assembly and the link are guided only by the pivots on the first part and by one pivot of a support element that connects the link to the housing. The pivots are formed as revolute pivots for example. In this way, the blade assembly is guided with respect to all spatial directions during movement between the rear position and the front position.

The features according to the invention make it possible for the blade support to be moved between the rear end position and the cutting position in an imaginary enveloping tunnel having a small cross-sectional area. As a result, a small housing can be constructed that simultaneously forms a handle.

The above-mentioned features furthermore make it possible to achieve significant movement in relation to the operating movement.

The guidance by the pivot pivots means that there is little friction, as a result of which effortless movement between the rear position and the front position takes place.

The actuator forms for example a four-bar linkage. The first part and the blade assembly are for example part of the four-bar linkage. Two links for example connect the first part and the blade assembly. In addition to the four-bar linkage, the mechanical linkage may also comprise further links. For example, the second part is likewise part of the mechanical linkage. The second part can for example also form a link. The second part is for example directly or indirectly movably connected to the four-bar linkage.

For example, at least one pair of links of the four-bar linkage are mutually parallel. Two links that interconnect the first part and the blade assembly are parallel for example. In this case, for example a parallelogram four-bar linkage can be formed.

According to an alternative, the links of the mechanical linkage are not arranged so as to be parallel. For example, the mechanical linkage may comprise an asymmetrical four-bar linkage. An asymmetrical four-bar linkage makes it possible for movement path of the blade assembly to be changed during movement between the rear position and the front position. These features make it possible for the blade to move between the safety position and the cutting position in a narrow movement tunnel.

According to an embodiment, at least two links of the mechanical linkage are of different lengths. For example, two links that interconnect the first part and the blade, are of different lengths. These features too make it possible for movement path and the position of the blade relative to the first part and/or the second part to be changed.

Each link of the actuator for example has just one direction of rotation during movement between the safety position and the cutting position. In other words, each link maintains the direction of rotation thereof and does not change the direction of rotation thereof during movement between the safety position and the cutting position.

According to an embodiment, at least two links of the actuator have the same direction of rotation during movement between the safety position and the cutting position. That is to say that the direction of rotation of one link has the same rotational orientation at least with respect to the direction of rotation of a second link.

An embodiment is characterized in that the blade assembly performs just a small pivot movement of α<45° or of α<30° or of α<10° or of α<5° during movement between the rear end position and the front end position. This feature ensures that the housing can be designed so as to be slim. Furthermore it is possible for the blade to carry out just a small angular change after emerging from the housing. This means that the risk of injury is low. In the case of knives from the prior art, the blade performs a large rotational movement of for example 50° after emerging from the housing. There was a relatively high risk of injury in the case of these knives.

Alternatively, for example the second part is displaceable relative to the first part.

The first part or the second part forms for example at least one slide that is movable relative to the other part in each case, i.e. relative to the second part or the first part. The slide is movably connected to the blade support. The slide is for example connected to the blade assembly or to at least one link or can be brought into contact with the blade such that the blade is movable between the safety position and the cutting position. For example, a slide for actuating the blade is provided on the opposite face of the utility knife. Alternatively, a slide may be provided on three utility knife faces, for example on the back of a utility knife and on opposite flanks of the utility knife. According to an alternative, the slide may also be molded onto the blade support or integrally connected thereto. The user can move the blade support by the slide.

According to an alternative, the second part is formed by a lever that together with the first part forms a pivot. The lever acts for example on the blade assembly or on at least one link of the actuator. In this way, for example, the first part and the second part can form a pincer-like actuator. The first part and the second part can for example be formed by two hingedly interconnected handle parts that are movable in the manner of pincers.

According to an embodiment, the first part and/or the second part form(s) a housing in which the blade is recessed in the safety position such that a user cannot come into contact with the cutting edge. It is important here for the housing to prevent injury on the blade. Impairment of the functional parts can also be prevented by the housing. The housing therefore does not have to be completely closed. It just simply fulfil the above-mentioned functions. The function can be fulfilled by a wire framework for example. The housing should for example be designed such that it can function as a handle of the utility knife. For example, the housing should be designed such that the user can firmly hold the handle and optionally grip all around the handle in the process without changing his grip during movement of the blade between the rear end position and the front end position.

In order to achieve this, it is advantageous for the blade to emerge from the housing only in a small region of the housing such that the blade can move out of the housing in this region without impeding the user when this user holds the utility knife by the handle.

In order to move the mechanical linkage, the second part is directly or indirectly movably connected to the mechanical linkage. For example, two links are connected to the first part and to the blade assembly in each case by a pivot-pivot. A support element is for example connected to the link of the mechanical linkage and to the second part such that a torque is generated about one of the pivots of the mechanical linkage during a relative movement between the first part and the second part, which torque moves the mechanical linkage. In this manner, the blade is movable for example between the end positions.

According to an embodiment, the first part is pivotable relative to the second part out of a base-position in a first direction into an actuated position in order to move the blade support into the cutting position.

In addition, for example the first part may be pivotable relative to the second part out of the base-position in a second direction into an open position in order to move the blade support into a blade replacement position. In the blade replacement position, the blade is accessible and can be replaced.

According to an alternative, the first part is pivotable, relative to the second part out of a base-position in a first direction beyond an actuated position in order to move the blade support into the blade replacement position. In this case, for example a detachable stop may be provided that limits movement of the blade support or the relative movement of the first part with respect to the second part and thus optionally defines the frontmost cutting position. When the stop is detached, the first part can be moved relative to the second part beyond the actuated position.

Further advantages will become clear from the description of an embodiment that is shown schematically in the drawings. In the drawings:

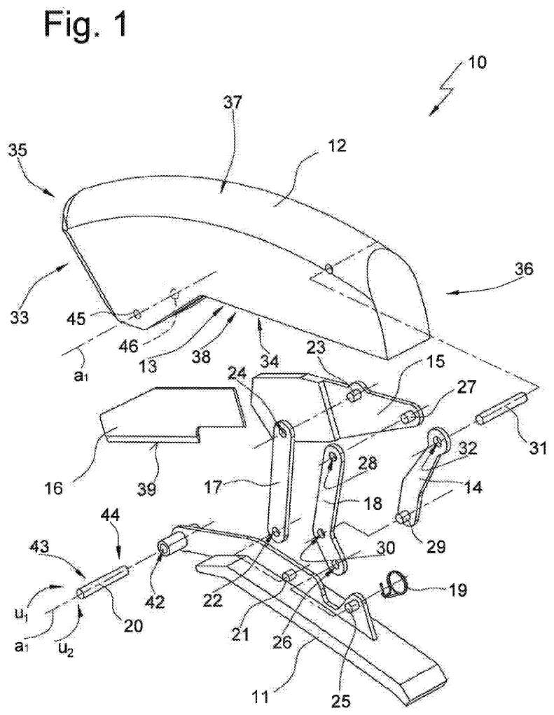

FIG. 1 is an exploded view of the utility knife,

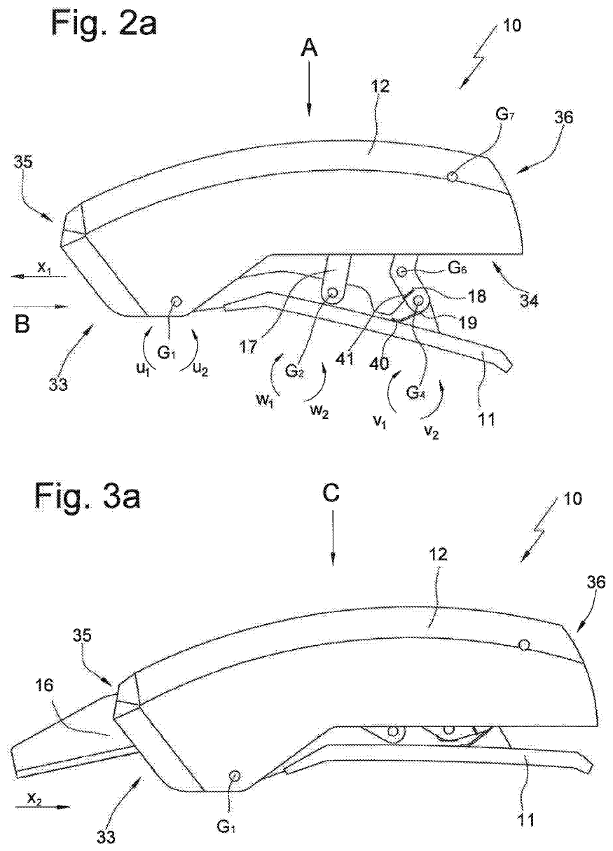

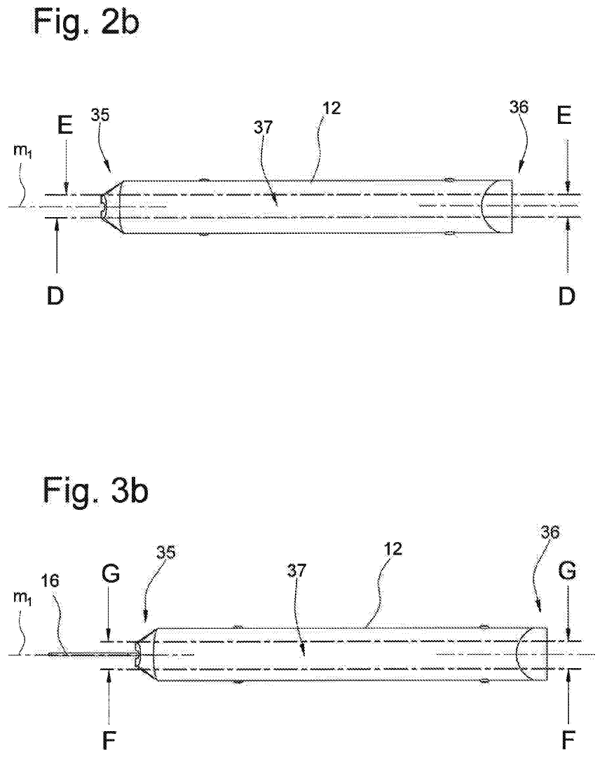

FIG. 2a is a side view of the unactuated utility knife with a blade assembly in the rear end position,

FIG. 2b is a plan view according to the arrow A in FIG. 2a,

FIG. 3a is a side view according to FIG. 2a in the actuated position,

FIG. 3b is a plan view according to the arrow C in FIG. 3a,

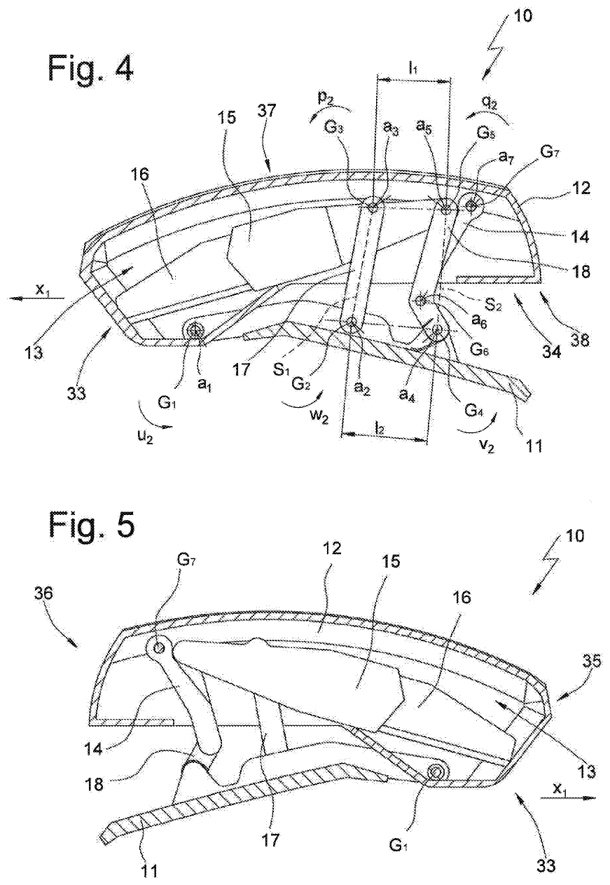

FIG. 4 is a section taken along section line D-D in FIG. 2b showing the blade assembly in the rear end position,

FIG. 5 is a section taken along section line E-E in FIG. 2b,

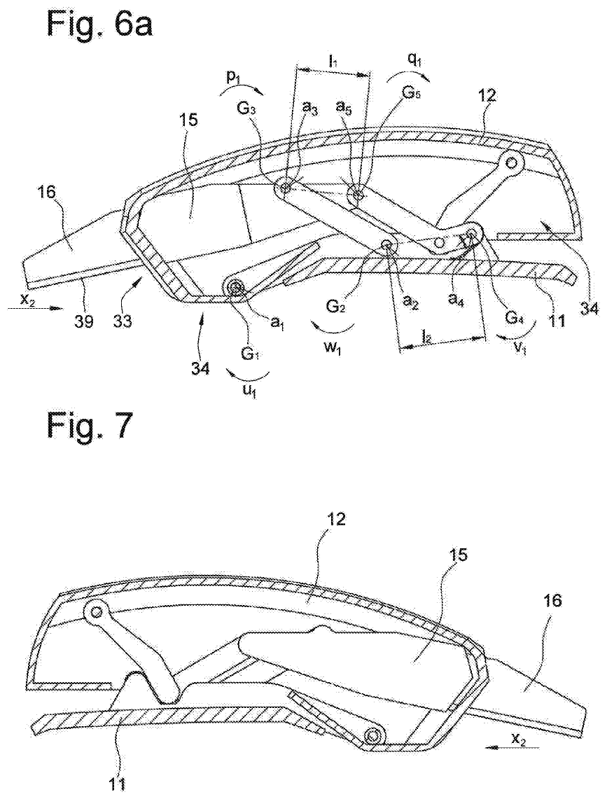

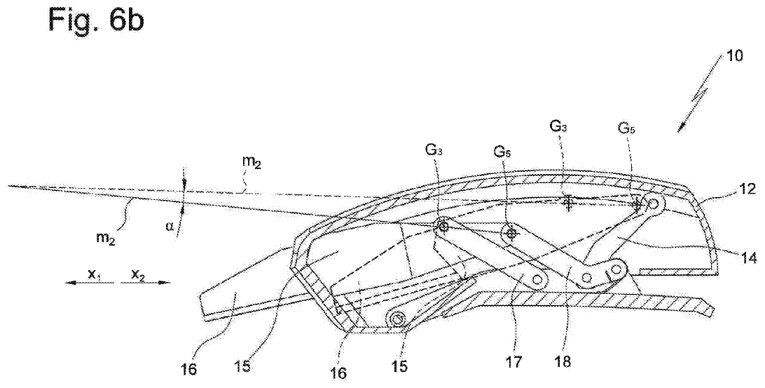

FIG. 6a is a section taken along section line F-F in FIG. 3b with the blade assembly in the front end position,

FIG. 6b is a section according to FIG. 6a with the position of the blade support in the rear end position according to FIG. 4 in dashed lines and the angular change of the blade shown,

FIG. 7 is a section according to the section line G-G in FIG. 3b,

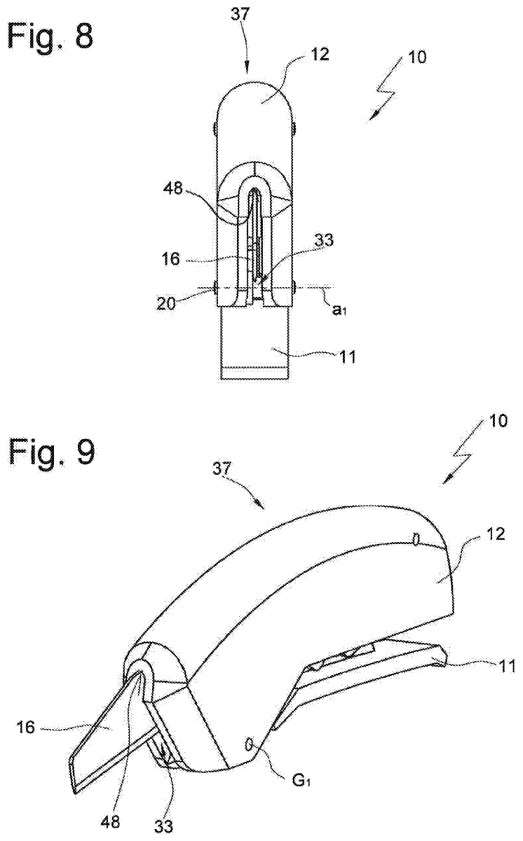

FIG. 8 is a view according to the arrow B in FIG. 2a,

FIG. 9 is a perspective view of the utility knife from the front with the blade assembly in the front position,

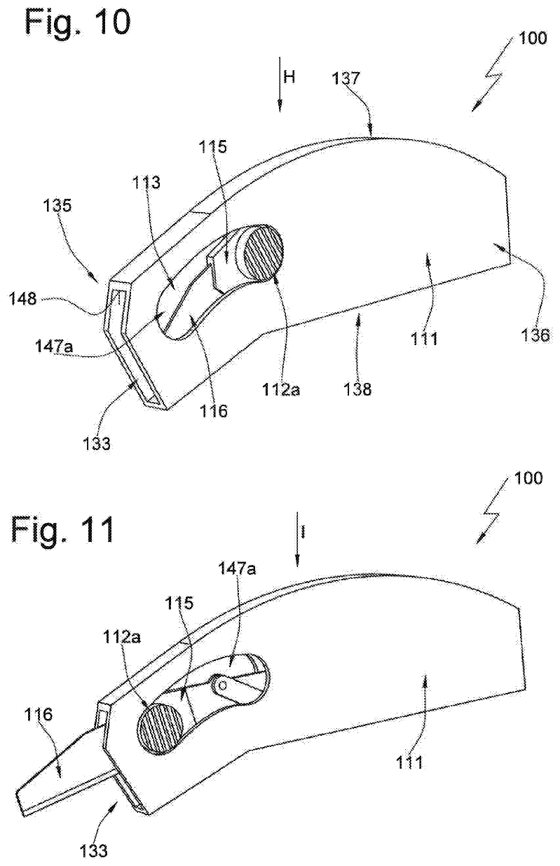

FIG. 10 is a perspective view of a second embodiment of the utility knife according to the invention with the blade assembly in the rear end position,

FIG. 11 is a view like FIG. 10 with the blade assembly in the front end position,

FIG. 12 is a plan view of the utility knife according to arrow H in FIG. 10,

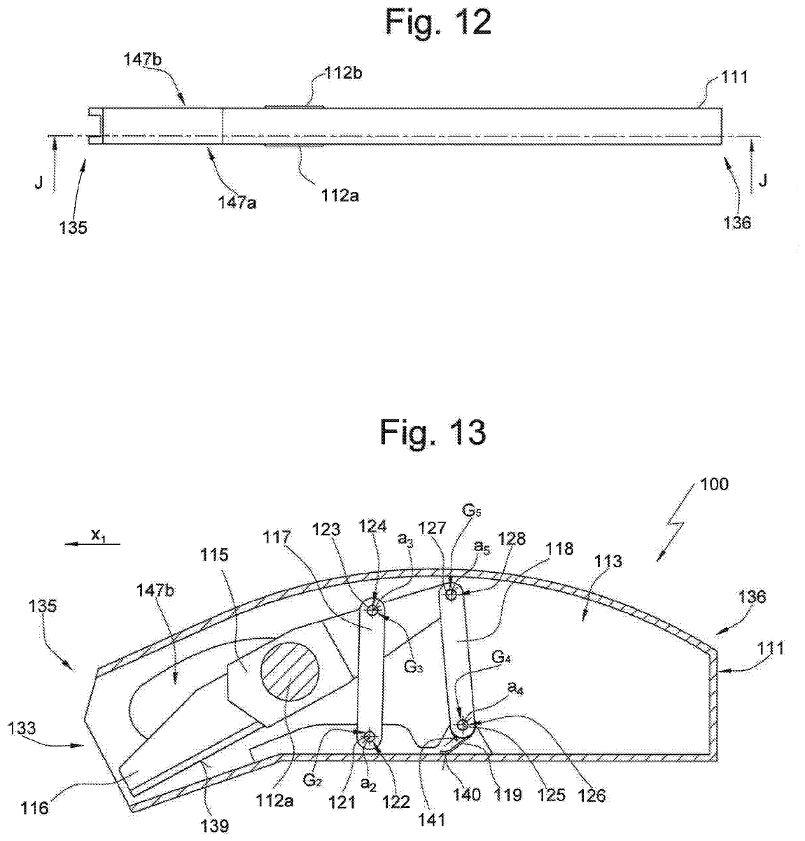

FIG. 13 is a section taken along section line J-J in FIG. 12,

FIG. 14 is a plan view of the utility knife according to arrow I in FIG. 11, and

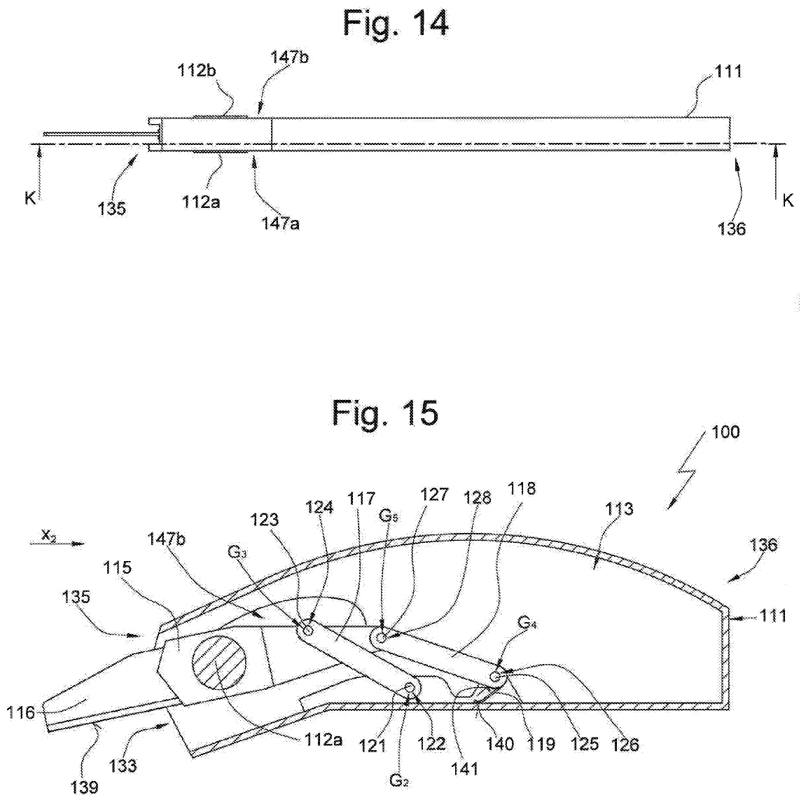

FIG. 15 is a section taken along section line K-K in FIG. 14.

Two embodiments of the invention are described by way of example in the following description of the figures, again with reference to the schematic drawings. In this case, for the sake of clarity, even in relation to different embodiments, the same or comparable parts or elements or regions are denoted by the same reference signs, sometimes with the addition of small letters.

Features that are described, shown or disclosed only in one embodiment can also be provided within the context of the invention in any other embodiment of the invention. Embodiments amended in this way are also covered by the invention, even if they are not shown in the drawings.

All the features disclosed are essential to the invention in their own right. The entire scope of the content of the disclosure of the cited documents and the described devices of the prior art is hereby also incorporated in the disclosure of the application, also for the purpose of incorporating individual or a plurality of features of the subjects disclosed therein into one or into a plurality of aspects of the present application. Embodiments amended in this way too are also covered by the invention, even if they are not shown in the drawings.

According to FIG. 1, the utility knife 10 comprises a first part 11 and a second part 12 that, together with the first part 11, forms a pivot G₁ having the axis a₁. The second part 12 can be pivoted in a direction u₁ toward the first part 11 or in the direction u₂ away from this first part. In the present embodiment, the relative movement between the first part 11 and the second part 12 is used for actuating the utility knife.

The second part 12 is formed as a housing and forms a chamber 13. The housing protects the user from injury from a cutting edge 39 of the utility knife 10 when the cutting edge 39 is inside the receiving chamber 13 and from injury on functional parts. Furthermore, the utility knife is protected from impairment of the mechanism such that reliable functioning is ensured.

The second part 12 has a front end 35 and a rear end 36. Furthermore, the utility knife forms an upper edge 37 and a lower edge 38. In this embodiment, the second part 12 is provided with openings 33 and 34. The opening 33 is at the front end 35 and is intended for the emergence of a blade 16. The opening 34 is formed on the lower edge 38 and allows for links 17 and 18 to extend through the edge of the second part 12.

The utility knife 10 is provided with a blade assembly that comprises the blade 16 and a blade support 15. The blade 16 is held firmly on the blade support 15 so as to be immovable relative to the blade support 15. The blade 16 can be released from the blade support 15 and replaced by another blade.

The utility knife 10 furthermore comprises an actuator that can move the blade assembly relative to the first part 11 and to the second part 12 between a rear end position and a front end position. The actuator comprises the links 17 and 18. The link 17 forms together with the first part 11 a lower pivot G₂ having a lower axis a₂ and together with the blade support 15 an upper pivot G₃ having an upper axis a₃. The link 18 forms together with the first part 11 a lower pivot G₄ having a lower axis a₄ and together with the blade support 15 and another upper pivot G₅ having an upper axis a₅. Alternatively, the links 17 and 18 can also form a pivot directly with the blade 16. In the present embodiment however a blade support 15 is provided that facilitates replacement of the blade 16.

A brace 14 (see FIG. 2a) forms with the link 18 a pivot G₆ having an axis a₆ and with the second part 12 a pivot G₇ having an axis a₇. The brace 14 limits the degree of freedom of the mechanical linkage.

The geometric pivot axes a₁ to a₇ of the pivot pivots G₁ to G₇ are oriented so as to be substantially at right angles to a longitudinal axis m₁ of the second part 12. The pivot G₁ (see FIG. 1) is formed by a first axle 20 that passes through a pivot hole 42 in the first part 11 and is anchored at both ends 43 and 44 in holes 45 and 46 on opposite walls of the second part 12.

The lower pivot G₂ is formed by a trunnion 21 of the first part 11 that engages in an end hole 22 in the link 17, and the upper pivot G₃ is formed by a trunnion 23 of the blade support 15 that engages in another end hole 24 in the link 17. Furthermore, the lower pivot G₄ is formed by a trunnion 25 of the first part 11 that engages in an end hole 26 in the link 18, and the upper pivot G₅ is formed by a trunnion 27 of the blade support 15 that engages in an end hole 28 in the link 18.

The brace 14 has a trunnion 29 that engages in a hole 30 of the link 18 in order to form the pivot G₆ and an axle 31 that is fastened at both ends on opposing walls of the second part 12 and that passes through a hole 32 of the brace 14 to form the pivot G₇.

It can be seen in FIG. 4, for example, that a spacing I₁ between the upper pivots G₃ and G₅ does not correspond to the spacing I₂ between the pivots G₂ and G₄. A connecting line S₁ between the pivots G₂ and G₃ is not parallel to a connecting line S₂ between the pivots G₄ and G₅, i.e. the four-bar linkage formed by the first part 11, the links 17 and 18 and the second part 12 is a asymmetrical. In this way, an advantageous movement path of the blade support 15 can be achieved that allows for a relatively slim housing.

A spring 19 is supported by its one end 40 (see FIG. 2a) on the first part 11 and by another spring end 41 on the link 18. The link 18 is urged by the spring 19 in the direction of rotation v₁.

In this way, the blade assembly comprising the blade support 15 and the blade 16 can be moved relative to the first part 11 between the front end position and the rear end position using the actuator. The first part 11, the blade support 15 and the links 17 and 18 form a mechanical linkage. The blade support 15 can be moved relative to the first part 11 through a coupler curve between a rear end position and a front end position. The blade support 15 is mounted exclusively on the links 17 and 18, i.e. it has no direct contact with the second part 12 during movement between the rear and the front end position.

The front end position is a cutting position in which the blade 16 projects out of the second part 12 such that a cutting process can be performed, and the rear end position is a safety position in which the cutting edge 39 of the blade 16 is protected by the second part 12 so as to be inaccessible to a user. The safety position is shown in FIGS. 2, 4 and 5, and the cutting position is shown in FIGS. 3, 6 and 7.

In the case of a movement of the second part 12 relative to the first part 11 in the direction u₁ the brace 14 applies a force against the link 18 that pivots the link 18 relative to the second part 12 about the axis a₄ in the direction v₂. In the process, as a result of the motion coupling of the mechanical linkage, the link 17 is also pivoted relative to the second part 12 about the axis G₂ in the direction w₂. The two links 17 and 18 also move the blade assembly through the coupler curve.

In the cutting position according to FIGS. 6 to 9, the cutting edge 39 of the blade 16 projects out of the opening 33 of the second part 12. When a force F is applied to the cutting edge 39 of the blade 16, the blade 16 can be supported on a support surface 48 of the edge of the opening 33. The force F then generates in the link 17 a torque in the direction w₂ about the axis a₂ and in the link 18 a torque in the direction v₂ about the axis a₄. These torques reduce the retaining force for holding the blade support 15 in the front end position or in another cutting position.

FIG. 6b shows that a straight line m₂ through the upper pivots G₃ and G₅ of the blade assembly comprising the blade 16 and the support 15 is pivoted by just a small angle α during movement between the rear position and the front position. This is a result of the nonparallel orientation and the different lengths of the links 17 and 18.

This action provides the advantage that the housing can be designed so as to be relatively slim. Furthermore, an advantage is achieved with respect the safety of the utility knife because the blade emerges from the first part only through a narrow slot, specifically the utility knife opening 33. After the blade 16 has emerged from the housing-like second part 12, the blade 16 executes just a slight rotational movement.

The functional sequence will be described in the following:

When the utility knife 10 is actuated in the rear end position of the blade support 15, i.e. in the case of relative movement of the first part 11 with respect to the second part 12 in the direction u₁, the brace 14 applies a force to the pivot G₆ that generates a torque in the link 18 about the axis G₄ in the direction v₂ and moves the link 18 in the direction v₂. In the case of rotation of the link 18 about the pivot G₄ in the direction v₂, the link 17 that is movably connected by the mechanical linkage moves about the pivot G₂ in the angular direction w₂. In the process, the blade support 15 is moved counter to the restoring force of the spring 19 into the cutting position in the direction x₁ over a movement path (or coupler curve) that is brought about by the four-bar linkage, and the link 17 rotates about the axis a₃ in the direction p₂ and the link 18 rotates relative to the blade support 15 about the axis a₅ in the direction q₂.

When the first part 11 and the second part 12 are unloaded, the spring 19 relaxes such that the link 18 pivots about the axis a₄ in the direction v₁ and the link 17 pivots about the axis a₂ in the direction w₁. The link 17 pivots relative to the blade support about the axis a₃ in direction p₁ and the link 18 pivots relative to the blade support 15 about the axis a₅ in direction q₁. The brace 14 moves the second part 12 relative to the first part 11 in the direction u₁. In the process, the blade support 15 moves back into the safety position in the direction x₂.

A second embodiment of the utility knife according to the invention is shown in FIGS. 10 to 15 and is denoted overall by reference 110.

The utility knife 110 comprises a housing 111 that forms the first part within the meaning of the invention, and an actuator comprising actuation attachments 112a and 112b. The actuator forms the second part within the meaning of the invention. The housing 111 forms a chamber 113 holding a movable blade support 115 carrying a blade 116. The housing 111 comprises a front end 135 and a rear end 136. Furthermore, the utility knife forms an upper edge 137 and a lower edge 138.

The blade support 115 is movable between a rear end position (see FIGS. 1 and 3) and a front end position (see FIGS. 11 and 13). The rear end position is a safety position in which the blade 116 is in the chamber 113 so as to be inaccessible for a user, and the front end position is a cutting position in which the blade 116 projects out of an opening 133 of the housing 112. Apart from the rear end position and the front end position, there are further safety positions of the blade assembly and further cutting positions. The opening 133 is provided on the front end 135 of the housing 111. The edge of the opening 133 forms a support surface 148 for the blade 116.

The actuation attachments 112a and 112b are actuated via arcuate throughgoing guide slots 147a and 147b in the housing 111. The fact that the user moves the blade support 115 forward in a direction x₁ via the actuation attachments 112a or 112b causes the blade assembly comprising the blade support 115 and the blade 116 to be displaced out of the safety position shown in FIG. 10 and into the cutting position shown in FIG. 11. The front end position is defined by when the actuation attachments 112a and 112b abut front ends of the slots 147a and 147b. As soon as the user removes the load form the relevant actuation attachment 112a or 112b, the blade support 115 is moved back into the safety position by a return spring.

The blade assembly can be moved between the rear end position and the front end position using an actuator. The actuator comprises links 117 and 118. The link 117 forms together with the housing 112 the lower pivot G₂ having the axis a₂ and together with the blade assembly, or in this embodiment the blade support 115, the upper pivot G₃ having the axis a₃. The link 118 forms together with the housing 112 the lower pivot G₄ having the axis a₄ and together with the blade assembly the upper pivot G₅ having the axis a₅. According to an alternative, the blade support 115 could also be omitted and the links 117 and 118 would in this case pivot directly on the blade 116.

The lower pivot G₂ is formed by a trunnion 121 of the housing 112 that engages in a hole 122 in the link 117, and the upper pivot G₃ is formed by a trunnion 123 of the blade support 115 that engages in a hole 124 in the link 117. Furthermore, the lower pivot G₄ is formed by a trunnion 125 of the first part 111 that engages in a hole 126 in the link 118, and the upper pivot G₅ is formed by a trunnion 127 of the blade support 115 that engages in a hole 128 in the link 118. The spacing between the pivots G₃ and G₅ is smaller than between the pivots G₂ and G₄.

The utility knife 110 thus forms a mechanical linkage (see FIG. 13) that comprises the housing 111, the blade support 115, and the links 117 and 118. On movement of the blade support 115 by one of the actuation attachments 112a or 112b, all the movably connected parts of the mechanical linkage are moved. By relative movement between the actuation attachment 112a or 112b and the housing 111, the blade support 115 can be moved between the rear end position and the front end position.

The blade support 115 is guided through a coupler curve by the mechanical linkage so that the blade support assumes a defined position at each point of the coupler curve. During movement between the rear end position and the front end position, the blade support does not need to be guided on the first part 111. In the present embodiment, the blade support 115 is guided exclusively by the links 117 and 118. Only in the case of elastic deformation of the links 117 and 118 owing to high loading of the blade 116, is it possible that the blade support 115 may be supported on the inside wall of the housing formed by the first part 111.

The coupler curve is designed such that a straight line m₂ through the pivots G₃ and G₅ pivots by no more than 45° during movement between the rear end position and the front end position. This feature ensures that the housing 112 is designed so as to be relatively slim such that the housing 112 can be easily held by one hand and that the blade 116 performs just a small pivot movement after emerging from the opening 133 as a result of which increased safety is achieved.

A spring 119 is supported on the housing 111 by one spring end 140 and on the link 118 by another spring end 141. The link 118 is urged by the spring 119 in the direction v₂ and the entire mechanical linkage including that of the blade support 115 is urged into the rear end position.

The mode of operation of the utility knife 110 will be described in the following:

Actuation of the blade support via one of the actuation attachments 112a or 112b moves the blade assembly between the rear end position and the front end position with the link 117 pivoting relative to the housing 111 about the axis a₂ in the direction w₂ and the link 118 pivoting relative to this housing about the axis a₄ in the direction v₂. The blade support 115 pivots relative to the link 117 about the axis a₃ and relative to the link 118 about the axis a₅. In the process, the blade support 115 and the blade 116 fastened therein are moved along the coupler curve and into the cutting position counter to the restoring force of the spring 119.

When the actuation attachment 112a or 112b is released, the spring 119 moves the link 118 in the direction v₁ and the link 117 moves in the direction w₁. In the process, the blade support is moved along coupler curve in the direction x₂ and back into the rear end position.

1. A utility knife comprising a first part and comprising:
a second part that is movable relative to the first part,
a blade assembly having a blade, and
an actuator having at least two links that hingedly interconnect the blade and the first part such that a mechanical linkage is formed that is movable by relative movement between the first part and the second part between at least one rear end position and at least one front end position, the second part being indirectly or directly movably connected to one of the links or to the blade assembly in order to move the mechanical linkage.

2. The utility knife according to claim 1, further comprising:
a restoring element urging the blade assembly the safety position.

3. The utility knife according to claim 1, wherein the mechanical linkage is a four-bar linkage including the two links that are mutually parallel.

4. The utility knife according to claim 1, wherein the mechanical linkage is a four-bar linkage including the two links that are not parallel to each other.

5. The utility knife according to claim 1, wherein the links of the mechanical linkage are of the same or of different lengths.

6. The utility knife according to claim 1, wherein each link of the mechanical linkage has just one direction of rotation during movement between the rear end position and the front end position.

7. The utility knife according to claim 1, wherein the links of the mechanical linkage have the same direction of rotation during movement between the rear end position and the front end position.

8. The utility knife according to claim 1, wherein the second part is formed by a slide that is movable in translation relative to the first part.

9. The utility knife according to claim 1, wherein the second part is formed by a lever that together with the first part forms a pivot.

10. The utility knife according to claim 1, wherein the first part or the second part forms a housing in which the blade is protected from contact at least in the safety position.

11. The utility knife according to claim 1, further comprising:
a support element hingedly connected to one of the links and to the first part or to the second part such that, on relative movement between the first part and the second part, the blade assembly is moved from the rear position into the front end position or into an intermediate position between the rear end position and the front end position.

12. The utility knife according to claim 1, wherein the first part is pivotable in a first direction out of a home position into an actuated position in order to move the blade assembly into a cutting position, and is pivotable in a second direction into an open position in order to move the blade assembly into a blade replacement position.

13. The utility knife according to claim 1, wherein the blade assembly performs just a small pivot movement of α<45° during movement between the rear end position and the front end position.

14. A utility knife comprising:
an elongated housing having two parts;
a blade support carrying a blade and movable longitudinally of the housing between a rear position with the blade retracted into the housing and a front position with the blade projecting out of a front end of the housing;
a four-bar linkage having two links each pivoted at one end on the blade support and at an opposite end on one of the parts of the housing, the links being nonparallel or of different lengths such that on movement between the end positions the blade support moves longitudinally and pivots;
an actuator movable relative to the housing for shifting the blade support between the end positions.

15. The utility knife defined in claim 14, wherein the actuator is the other part of the housing and the opposite ends of the links are pivoted on the other part.

16. The utility knife defined in claim 15, wherein the other part of the housing is pivotal on the housing between an actuated position close to the one part and an open position separated from the one part, the knife further comprising:
a brace pivoted on the blade support and on the pivotal other part of the housing for pushing the blade support longitudinally forward on pivoting of the other part from the open position to the actuated position.

17. The utility knife defined in claim 14, wherein the actuator includes an actuator element fixed on the blade support, accessible from outside the housing, and slidable in an arcuate guide slot formed in the one part.
